(19) United States
(12) Patent Application Publication
(10) Pub. No.: US 2005/0197934 A1
(43) Pub. Date: Sep. 8, 2005

(54) Method and system for supplementing directors' and officers' insurance

(76) Inventors: Barry Finkelstein, ., NY (US); Brian Barrett, Irvington, NY (US); Steve Padovano, Fair Haven, NY (US); Linda Lowry, Brooklyn, NY (US); Marlene Debel, Woodbury, NY (US); Eric Steifman, New York, NY (US); Thomas Visone, Millburn, NJ (US); John Fromholtz, Leonia, NJ (US); Russell L. Stein, Englewood Cliffs, NJ (US)

Correspondence Address: OPPEDAHL AND LARSON LLP, P O BOX 5068, DILLON, CO, 80435-5068, US

(21) Appl. No.: 10/711,810

(22) Filed: Oct. 6, 2004

Related U.S. Application Data
(60) Provisional application No. 60/521,182, filed on Mar. 4, 2004.

(51) Int. Cl. G06F 17/60

(52) U.S. Cl. 705/35

(57) ABSTRACT

A first trust sells a credit derivative to a second trust, and in this way provides for funding of the second trust and thus provides bankruptcy protection to the second trust. The first trust sells notes linked to the credit of a sponsor. With the proceeds the first trust purchases bonds with very little risk, such as US treasury bonds. At the end of a specified period, such as five years, and in the absence of a bankruptcy of the sponsor, the first trust liquidates the bonds and redeems the notes. In the event of a bankruptcy of the sponsor, the bonds are liquidated and a pre-determined portion, such as two-thirds, of the proceeds are used to redeem the notes, while the remainder of the proceeds are transferred to a second trust pursuant to the credit derivative. The second trust funds indemnification and defense-like protection for the directors and officers of the sponsor. In the event that proceeds remain after claims are processed, the remainder is donated to a charity.

### CROSS-REFERENCE TO RELATED APPLICATIONS

This application claims priority from U.S. application No. 60/521,182 filed Mar. 4, 2004, which application is incorporated herein by reference for all purposes.

### TECHNICAL FIELD

The invention relates generally to the supplementation of officers' and directors' insurance, and relates more specifically to providing such supplementation in the event of bankruptcy of a sponsoring entity.

### BACKGROUND ART

For many decades it has been commonplace for corporations and other entities to provide indemnification and insurance for directors and officers. Statutes in many jurisdictions permit or require corporations to indemnify their directors and officers for some losses, and authorize corporations to purchase D&O (directors' and officers') insurance to cover other losses. Such provisions are very important, because D&O litigation can be extremely expensive. Such litigation can lead in some circumstances to settlements or judgments in of tens of millions of dollars or more, and defense costs can be comparable in magnitude.

In recent years, directors and officers liability insurance has become a core component of corporate insurance. It is estimated that as many as 95% of Fortune 500 companies maintain directors' and officers' liability insurance today. Furthermore, it has become a commonplace of the financial world that disappointed investors will charge corporations and their officers and directors with securities fraud whenever a company's stock drops significantly in price. Studies estimate that the average settlement of securities fraud litigation in 1999 was greater than $8 million, with average defense costs exceeding $1 million.

Historical approaches for such indemnification and insurance have limitations and drawbacks.

One potential limitation with indemnification is that the corporation may be financially unable to fund the indemnification, either because it is insolvent or because it has cash-flow limitations. Even for a financially solvent corporation, the cost of D&O litigation can be so great as to risk impairing corporation's other business activities. This can present the corporation with a difficult decision such as whether to abandon a defendant director and officer in lieu of jeopardizing the corporation's continuing existence or financial health.

As a special case of this problem, if the corporation enters bankruptcy, the bankruptcy trustee is likely to assume control of all of the assets of the corporation for the benefit of creditors, thereby making the assets unavailable for use for indemnification.

In the case of US law, and in the event of a corporation's bankruptcy, the automatic-stay provision of the US bankruptcy law protects the corporation from lawsuits, but actions against the directors and officers are not stayed. This highlights the need for protection of the directors and officers separate and apart from any protection afforded by indemnification by the corporation.

Traditional D&O liability insurance is used to provide coverage for indemnifiable and non-indemnifiable claims. Such insurance is of course helpful but does not fully address all of the relevant concerns. One problem is that many insurers in recent years are unwilling to write policies for a term exceeding one year. Yet another problem is that under US bankruptcy law, a bankruptcy trustee may exercise the power to undo transactions entered into prior to the bankruptcy filing; under certain circumstances transactions entered into as much as a year prior to the filing may be undone. The bankruptcy trustee may attempt to take the position that such an insurance policy is an asset of the estate. For example, in dividing up the estate of the bankrupt, some US courts have held that insurance policies are part of the estate, although the proceeds may not be. If the policy and its proceeds are property of the estate, the insureds may need bankruptcy-court approval to obtain proceeds from the insurer. Such approval may take a long time, during which time the insureds such as directors and officers might be without the benefit of legal defense paid for by the insurance.

Some insurance policies cover the corporation itself as well as the directors and officers, and from the point of view of the directors and officers there may be a risk that the coverage limit may exhausted merely from the coverage of the corporation. Many traditional D&O liability policies also have “notice” requirements which lead to coverage disputes; the insurer may question whether notice by a claimant was timely given.

Another potential problem is that with some traditional D&O insurers, when the claim against the insureds alleges fraud, the insurer may attempt to rescind the policy, arguing that the application failed to disclose the fraud.

Finally, in recent times traditional D&O insurance, for some types and sizes of company as well as some coverage limits, is unavailable at any price, or is available only at premium levels that are high enough to be uneconomic.

It might be suggested that one approach would be for the corporation to pay money to each director and officer and to let each director or officer purchase his or her own insurance. Transaction costs and loss of certain economies of scale make this approach uneconomic.

Another historical approach is for the corporation to set up a “captive” insurance company. In this approach the corporation sets up an insurance company largely (or solely) for the purpose of providing particular coverage. This approach also has some drawbacks, among them that in the event of bankruptcy of the corporation, the bankruptcy trustee may attempt to take control of the captive insurance company as an asset of the bankrupt estate. The bankruptcy court may order an equitable consolidation of the parent and captive subsidiary, thereby sweeping the captive subsidiary's assets into the bankruptcy proceeding of the parent corporation. In effect, this remedy allows third-party creditors to assert claims against a common fund.

Yet another historical approach is a “fronting” insurance arrangement—an agreement between a corporation and a traditional insurance company pursuant to which the insurance company issues a standard or perhaps enhanced D&O insurance policy in exchange for the corporation agreeing to fund all (or at least a substantial portion of all) loss under that insurance policy. The insurance company receives a fee for its services in providing a “fronting” policy, but assumes no or very little risk of loss. This too has a drawback in that bankruptcy of the corporation may lead to loss of protection.

Finite risk programs are similar to fronting arrangements. Although the exact terms and structure of such a program vary, generally an unrelated insurer affords a defined amount of coverage over an extended period of time in exchange for which the insureds agree to pay a very large initial premium and/or agree to pay a certain percentage of loss incurred under the program. This approach is adversely affected by bankruptcy of the corporation, and can have the other drawbacks listed previously for traditional insurance.

Still another historical approach for securing financial protection to directors and officers is an irrevocable trust. The corporation establishing the trust typically enters into a trust agreement with a bank or other third party as trustee and transfers a sum of money to the trustee to be held in trust pursuant to the provisions of the agreement. The trust agreement may provide that the corporation will keep the value of the trust assets at a given level at all times, or it may provide for a single contribution or annual contributions. The trust agreement typically reads substantially similar to a D&O insurance policy, with the covered directors and officers being the designated beneficiaries. One drawback to this approach is that to obtain a particular level of coverage, that amount of money must be found and made available to the trust. Some corporations do not have enough cash to spare to set up such a trust. A bankruptcy trustee may well attempt to gain control of such assets as well.

Returning to indemnification approaches, a corporation may enter into indemnification contracts with its directors and officers and secure coverage afforded by those contracts with a letter of credit (“LOC”), surety bond or other similar arrangement. Like many of the alternatives summarized above, these arrangements can protect directors and officers against unilateral amendments by the corporation to the indemnification protection and against other unforeseen changes in circumstances. Such an approach is often uneconomic in recent times.

As mentioned briefly above, it is important when considering approaches for protecting directors and officers to take into account what might happen upon bankruptcy of the corporation. If a goal is to assure a source of funding, it is essential that the arrangement be structured to insulate funds from potential claimants who may seek to apply the funds for purposes other than protecting the directors and officers. For example, creditors or a bankruptcy trustee may seek to recoup for their benefit the corporate assets used to fund the alternative arrangement under fraudulent conveyance or bankruptcy preference statutes.

It is thus apparent, from the discussion above, that there is a great need for approaches for protecting and insuring directors and officers that can supplement previous approaches such as indemnification and traditional insurance. There is a need, in particular, for supplemental approaches that fill gaps that arise in the event of bankruptcy of the corporation.

### DISCLOSURE OF INVENTION

A first trust sells a credit derivative to a second trust, and in this way provides for funding of the second trust and thus provides bankruptcy protection to the second trust. The first trust sells notes linked to the credit of a sponsor. With the proceeds the first trust purchases bonds with very little risk, such as US treasury bonds. At the end of a specified period, such as five years, and in the absence of a bankruptcy of the sponsor, the first trust liquidates the bonds and redeems the notes. In the event of a bankruptcy of the sponsor, the bonds are liquidated and a predetermined portion, such as two-thirds, of the proceeds are used to redeem the notes, while the remainder of the proceeds are transferred to a second trust pursuant to the credit derivative. The second trust funds protection for the directors and officers of the sponsor. In the event that proceeds remain after claims are processed, the remainder is donated to a charity.

### BRIEF DESCRIPTION OF THE DRAWINGS

The invention will be described with respect to a drawing in several figures.

FIG. 1 is a flow diagram showing entities and transactions relating to the setting-up of a system according to the invention.

FIG. 2 is a flow diagram showing entities and transactions relating to a system according to the invention in the event of a bankruptcy.

FIG. 3 is a time line showing an imbricated embodiment of the invention.

Where possible, like items have been depicted with like reference numerals.

### MODE FOR THE INVENTION

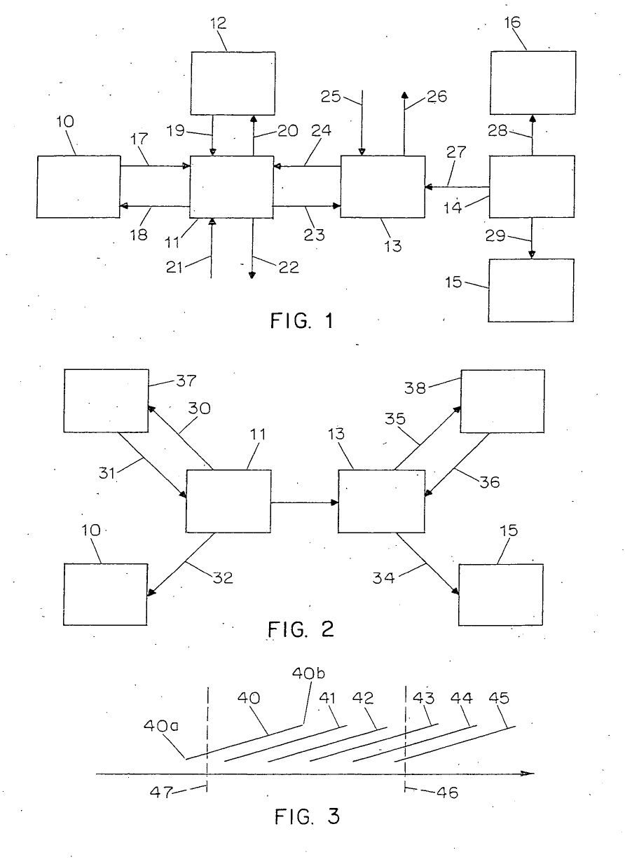

In an exemplary embodiment, a sponsoring corporation 14 (FIG. 1) establishes trust 13 as a means of providing supplementary protection to its directors, officers and employees in the event of a bankruptcy of the sponsor. For example the trust 13 can be formed under Bermuda law.

The sponsor 14 also establishes a trust 11 which can be a Credit Linked Note Trust (“CLN Trust”) to provide a means of funding trust 13 in the event of a bankruptcy of sponsor 14.

Upon closing, a number of events take place. Trust 13 purchases from the trust 11 (typically) five-year bankruptcy protection. Under the terms of such protection, trust 11 is required to fund trust 13 with a predetermined amount of money, for example one hundred million dollars, in the event of a bankruptcy of sponsor 14. The payment obligation of trust 11 will be secured by highly rated securities 12 such as Aaa/AAA-rated securities. In another embodiment, the payment obligation of trust 11 is secured by treasury bonds rather than such securities, so as to provide lower risk.

Trust 11 issues notes to investors 10. The issuance proceeds 17 (for example three hundred million dollars) are used to acquire securities 12.

Sponsor 14 pays to trust 13 an amount 27 sufficient to pay trust 11 a premium 24 for the credit protection. For example the amount 27 may be 128.50 basis points per annum which is sufficient for a payment 24 of 120 basis points per annum to trust 11. (A “basis point” is one one-hundredth of a percent.) Trust 11 uses this amount as a payment 22 to purchase Treasury Strips 21 which defease the obligation on the part of trust 11 to pay interest 18 to note holders (investors) 10. In a typical example the interest 18 represents a spread over a standard interest rate such as the London Interbank Offer Rate (“LIBOR”). As will be appreciated in view of the discussion that follows, this interest rate is selected to take into account the perceived risk that the sponsor 14 will go bankrupt during the term of the trust 11. (A typical term is five years.) In this way the notes sold to the investors 10 are linked to the credit of the sponsor 14.

In an exemplary situation an underwriter (omitted for clarity in FIG. 1) may underwrite the sale of the notes to the investors 10. For example there are existing financial products with a sufficiently efficient market to permit knowledgeable selection of an interest rate for the notes that suffices to reflect the credit risk of the sponsor 14, thus permitting carrying out the offering with some level of confidence on the part of the underwriter. In another embodiment the notes may be sold in a private placement to private-placement investors.

The amount 27 paid by sponsor 14 is selected not only to permit payment of premium 24 to trust 11, but is also selected to make possible a payment 26 (for example, the present value of 8.5 basis points per annum) that the trust 13 uses to purchase a Treasury strip maturing on the fifth anniversary of the closing date.

The trust 13 issues a trust certificate indicative of a beneficial interest to sponsor 14, which sponsor 14 donates 29 to a charity 15, for example an offshore charity.

In this embodiment, sponsor 14 pays to entity 16 an amount sufficient to cover structuring and transaction-related fees and expenses. For example this payment can be 69 basis points.

It will be appreciated that in this way, trust 11 is providing credit protection 23 in a predetermined amount such as one hundred million dollars. The terms of the credit protection 23 may for example be terms standardized by the International Swaps and Derivatives Association, Inc. (“ISDA”).

Sequence of events if the sponsor does enter bankruptcy. The trusts are set up so that if the sponsor does not enter bankruptcy during the five-year period, trust 13 will terminate at the end of the five-year period, with the proceeds 25 of the Treasury strip going to the charity 15. The notes held by the investors 10 mature and are redeemed with principal from bonds 12, and the trust 11 terminates.

FIG. 2 is a flow diagram showing entities and transactions relating to a system according to the invention in the event of a bankruptcy.

In the event of a bankruptcy of sponsor 14, the assets of trust 11 are sold (arrow 30). Recall that these assets in an exemplary ambodiment are bonds 12. (It will be appreciated that it is advantageous when initially selecting the bonds 12 to choose a type of bond that is very liquid.) With the proceeds 31 from the sale, trust 11 pays a fixed recovery 32 (in this example, 66%) to the note holders 10, with the remainder 33 going to the trust 13. Thus for example three hundred million dollars' worth of bonds 30 are liquidated to yield three hundred million dollars of cash 31, with two hundred million dollars 32 going to the note holders and one hundred million dollars 33 going to trust 13.

If the trust 13 does fund (that is to say, if it receives funds 33), the the funds are invested in cash equivalents and are available (for a predetermined period, for example seven years) to reimburse 35 the expenses and obligations incurred by specified directors or officers (and any other employees) 38 specified in the trust agreement establishing trust 13. For example a director or officer may present a claim 36 which later gives rise to a disbursement 35. The sponsor 14 determines the payment provisions of the agreement establishing trust 13. For example the agreement may specify that a claim is timely made if made promptly after the funding of the trust 13 (that is, promptly after the event of bankruptcy).

In an exemplary embodiment an administrator (omitted for clarity in FIG. 2) is hired to administer claims made with respect to the assets of trust 13.

In an exemplary embodiment, at the end of seven years, any funds 34 remaining in trust 13 are distributed to the holder of the above-mentioned trust certificate 29, that is, the offshore charity 15.

In this exemplary embodiment, it is assumed that the assets of trust 13 that are available to pay claims 36 (FIG. 2) will not be considered assets of the bankruptcy estate of sponsor 14.

Under applicable accounting rules, it is anticipated that the sponsor 14 would be required to consolidate the trust 13 for accounting purposes. It will be appreciated that the primary asset of the trust 13 is the credit default swap linked to the credit of the sponsor 14. It is expected in many cases that the sponsor 14 will have a policy not to mark its own credit spreads “to market” for accounting purposes; stated differently the credit default swap will not be “marked to market.” In the event of a bankruptcy of the sponsor 14, the trust 13 receives cash 33 (FIG. 2) on the credit default swap and records a liability to the minority interest holders.

It is anticipated that the sponsor 14 will expense the premium 27 paid to the trust 13 over the term of protection, in this example, five years.

From the above discussion it will be appreciated that the system and method only provide coverage for the directors and officers 38 in the particular case of the sponsor 14 entering bankruptcy. Thus as a general matter it would be expected that the invention would not be used in isolation but instead as a supplement to other measures such as indemnification obligations and insurance.

From the above description it will be appreciated that the system and method provide protection only in the event that a bankruptcy occurs during the five-year term of the trust 11. If the five-year term passes without any event of bankruptcy, the trust 11 terminates. It will be further appreciated that an imbricated (overlapping) approach is a desirable approach.

It is instructive to consider the steps described above from the point of view of the investor or investors who purchase the credit linked notes. The investors pay (in this example) $300 million for the notes, and they receive interest payments (in this example) of LIBOR plus 40 basis points. In the absence of bankruptcy, at the end of the term (in this example, five years) their notes are redeemed for the$300 million principal amount. In the event of bankruptcy during the term, they get $200 million. Because the trust 11 holds high-grade securities, and because the trust is obligated to give (in this example) two-thirds of the proceeds from bankruptcy-triggered liquidation to the note holders, the notes may be fairly characterized as having a limited downside risk given that even in the worst case the note holders get (in this example) 66 cents on the dollar.

It is also instructive to consider the steps and arrangement described above from the point of view of a director or officer. The director or officer is aware that the trust arrangement has been set up. In the event of bankruptcy of the sponsoring corporation, the director or officer is able to present claims for the coverage, and the ability of the trust 13 and administrator to carry out their work (that is, to pay claims and to provide legal defense) is unhampered by the bankruptcy filing.

FIG. 3 is a time line showing an imbricated embodiment of the invention. A first trust arrangement 40 created by means of the steps described above is established at time 40a, and in the absence of a bankruptcy it terminates in (for example) five years at time 40b. A second trust 41 is created at a later time, a third trust 42 is created at a still later time, and so on for additional trusts 43, 44, 45 and so on. For example trusts 40, 41, etc. may be created once a year. such an imbricated approach a distinction may be drawn between the initial periods and a steady-state condition.

For an example of a steady-state condition, line 46 denotes the various trust arrangements 43, 44, and 45 existing at the time of line 46. Each of the three trust arrangements will be available to receive claims 36 in the event of bankruptcy at the time of line 46.

In contrast, at an initial time of line 47, only one trust arrangement 40 exists and is available in the event of bankruptcy to receive claims 36.

It will thus be appreciated that an initial trust arrangement 40 might be funded at a fairly high level (to provide, say, one hundred million dollars of protection), while subsequent trust arrangements (such as arrangements 43, 44, 45) might each be funded at lower levels selected to add up to one hundred million dollars.

From the above discussion it will be apparent that it may be helpful to select some or all of the investors 10 to be private-placement investors. The reason for this is that it may prove possible to sell notes in tranches having differing terms, such as three, five, or seven years. This may permit funding several of the layers shown in FIG. 3, all at the outset of the establishment of the system. In contrast if all of the investors 10 are simply purchasers in an established market where all of the maturities have the same term, it may be more difficult simultaneously to fund both an initial and subsequent trust arrangements.

In the embodiment described above, there is what may be termed a credit default swap between the trust 13 and the trust 11, the latter being a credit-linked-note trust. Another possible approach would be a credit default swap by the trust 13 directed with a counterparty. Of course in such an arrangement it is important to select a counterparty that can be counted upon to fulfill its obligation, in this case, the obligation to fund trust 13 in the event of bankruptcy.

It is instructive to review the overall cost to the sponsor to set up such a trust arrangement as is described in connection with the invention. Some older approaches such as the captive insurance company or dedicated trust described in the background section above are able to be set up only if an amount of money equal to the policy limit is found somewhere among the corporation's liquid assets, and is given to the captive insurance company or trust. For a hundred million dollars of coverage the corporation must find a hundred million dollars to spare, and this money is tied up for the duration of the coverage. The need to fund fully the insurance company or dedicated trust might turn out to be beyond the means of a particular corporation. As mentioned above, some corporations may find that they do not have that much money to spare. If an imbricated arrangement along the lines of FIG. 3 is desired for the dedicated trust or for the captive insurance company, the corporation would need to find more money every year or so that can be pumped into the captive insurance company or dedicated trust.

In contrast, in the arrangement according to the invention, for (say) a hundred million dollars of coverage extending over a full five years, the amount of money that the corporation needs to find it can spare is far less than the coverage limit. Instead, the corporation needs only to find enough money to set up the trusts and to cover the interest-rate spread required to enable sale of the credit-linked notes. That spread is related to the market rate for a credit default swap for that corporation and for the term involved. In a typical case this might be only the present value of about 128 or so basis points, which is a lot less money than the coverage amount obtained.

It will be appreciated that the precise term of the trust arrangement is not critical to the invention. For example the embodiment above assumes that trust 11 has a term of five years. This term is selected to be rather longer than one year, in part because many commercial insurers decline to write policies for terms longer than one year, and in part because under US bankruptcy law a trustee in bankruptcy is empowered to roll back transactions that are up to a year old under certain circumstances. The term is also chosen by taking into account periods of time for which credit default swaps have well-established market prices, so as to permit ready selection of a spread over a reference interest rate for the credit-linked notes. This facilitates the underwriting of an offering of such notes.

The embodiment described above assumes that the trust arrangement is set up for a particular single sponsor along with its directors and officers. It should be appreciated, however, that under some circumstances (e.g. sponsors that are easily able to afford the setup costs) it may be possible to set up pooled arrangements where two or more sponsors contribute to a trust arrangement. The setup costs would thus be capable of being spread among several sponsors, and there is the possibility that a smaller spread would be needed due to diversification across multiple sponsors. Suitable provisions would, in a pooled arrangement, be needed to protect the non-bankrupt sponsors in the event of bankruptcy of one of the sponsors. One approach would be, in the event of bankruptcy of one of the sponsors, to spin off the proceeds associated with the non-bankrupt sponsors into a new trust arrangement for those sponsors.

The embodiment described above refers to a particular triggering event relating to the credit of the sponsor, namely entry into bankruptcy. It will be appreciated that depending on the legal jurisdiction of the sponsor, the possible triggering events might include a bankruptcy filing by the sponsor, an entry into bankruptcy proceedings due to a filing by one or more third parties, or an assignment for the benefit of creditors under state law. For convenience of discussion these possible triggering events may be collectively termed “credit events.”

It may also be possible to apply this invention to triggering events other than credit events such as bankruptcy. For example if a particular corporation were desirous of supplementing coverage in the event of a stock price drop, it might be possible to set up a funding trust, or counterparty, that would fund the trust 13 in the event of a pre-determined stock price drop.

The embodiment set forth above is described in connection with D&O protection. It should be appreciated that the invention may well find fruitful application with respect to risks other than the types of risks to which D&O insurance is directed.

The exemplary embodiment assumes a sponsor based in the US, and assumes trusts located in Bermuda. It will be appreciated, however, the invention may well be able to offer its benefits and advantages in other geographic locations. The need to protect directors and officers is not, for example, limited to US corporations. Depending on the tax laws, bankruptcy laws, and accounting rules in effect in a particular country, the invention may well offer its benefits for corporations in that country.

While the invention has been described with respect to particular embodiments, the invention is not limited to those particular embodiments. Persons skilled in the art will have no difficulty devising myriad obvious variations and obvious improvements upon the invention, without departing in any way from the invention, and all such obvious variations and improvements are intended to fall within the scope of the claims which follow.

1. A method practiced with respect to a sponsor having credit and with respect to directors and officers of the sponsor, the method comprising the steps of:
establishing a first trust;
establishing a second trust;
arranging for the first trust to sell securities linked to the credit of the sponsor,
the proceeds of the sale defining first value, the sale occurring on a first date;
obligating the first trust to transfer a first portion of the first value to the second trust in the event of a credit event with respect to the sponsor occurring within a first interval of the first date, thereby defining a second portion of the first value in the first trust;
in the event of the credit event, obligating the second trust to provide indemnification and defense services for the directors and officers, the indemnification and defense services paid for by the first portion of the first value.

2. The method of claim 1 wherein the credit event is bankruptcy of the sponsor.

3. The method of claim 1 wherein, if the first interval passes in the absence of a credit event with respect to the sponsor, the securities are redeemed.

4. The method of claim 1 further comprising the step, in the event of the credit event, of redeeming the securities at a price defined by the second portion of the first value.

5. The method of claim 4 wherein the second portion of the first value comprises more than half of the value.

6. The method of claim 5 wherein the second portion of the first value comprises at least two-thirds of the value.

7. The method of claim 1 wherein the first interval is an interval greater than one year.

8. The method of claim 7 wherein the first interval is an interval of at least three years.

9. The method of claim 8 wherein the first interval is an interval of at least five years.

10. The method of claim 1 further comprising the step of:
obligating the second trust, after the passage of a second interval after the credit event, to pay monies left over after provision of the indemnification and defense services to a charity.

11. The method of claim 1 further comprising the step of transferring second value from the sponsor to the first trust, said second value selected to induce sale of the securities.

12. The method of claim 1 further comprising a first repetition of the steps of claim 1 at a first later time.

13. The method of claim 12 further comprising a second repetition of the steps of claim 1 at a second time later than the first later time.

14. The method of claim 13 wherein the first later time is a year later, and the second later time is a year after the first later time.

15. A method practiced with respect to a sponsor having credit and with respect to directors and officers of the sponsor and with respect to a first trust and a second trust, the first trust obligated to sell securities linked to the credit of the sponsor, the proceeds of the sale defining first value, the sale occurring on a first date; the first trust obligated to transfer a first portion of the first value to the second trust in the event of a credit event with respect to the sponsor occurring within a first interval of the first date, thereby defining a second portion of the first value in the first trust; the second trust obligated, in the event of the credit event, to provide indemnification and defense services for the directors and officers, the indemnification and defense services paid for by the first portion of the first value; the method comprising the step of:
transferring second value from the sponsor to the first trust, said second value selected to induce sale of the securities.

16. The method of claim 15 wherein the credit event is bankruptcy of the sponsor.

17. The method of claim 15 wherein, if the first interval passes in the absence of a credit event with respect to the sponsor, the securities are redeemed.

18. The method of claim 15 further comprising the step, in the event of the credit event, of redeeming the securities at a price defined by the second portion of the first value.

19. The method of claim 18 wherein the second portion of the first value comprises more than half of the value.

20. The method of claim 19 wherein the second portion of the first value comprises at least two-thirds of the value.

21. The method of claim 15 wherein the first interval is an interval greater than one year.

22. The method of claim 21 wherein the first interval is an interval of at least three years.

23. The method of claim 22 wherein the first interval is an interval of at least five years.

24. The method of claim 15 further comprising the step of:
obligating the second trust, after the passage of a second interval after the credit event, to pay monies left over after provision of the indemnification and defense services to a charity.

25. The method of claim 15 further comprising a first repetition of the steps of claim 15 at a first later time.

26. The method of claim 31 further comprising a second repetition of the steps of claim 15 at a second time later than the first later time.

27. The method of claim 26 wherein the first later time is a year later, and the second later time is a year after the first later time.

28. A method practiced with respect to a sponsor having credit and with respect to directors and officers of the sponsor, and with respect to a first trust and a second trust, the first trust obligated to sell securities linked to the credit of the sponsor, the proceeds of the sale defining first value, the sale occurring on a first date, the first trust obligated to transfer a first portion of the first value to the second trust in the event of a credit event with respect to the sponsor occurring within a first interval of the first date, thereby defining a second portion of the first value in the first trust; the method comprising the step of:
by an director or officer, receiving indemnification and defense services from the second trust, the indemnification and defense services paid for by the first portion of the first value.

29. The method of claim 28 wherein the credit event is bankruptcy of the sponsor.

30. The method of claim 28 wherein, if the first interval passes in the absence of a credit event with respect to the sponsor, the securities are redeemed.

31. The method of claim 28 further comprising the step, in the event of the credit event, of redeeming the securities at a price defined by the second portion of the first value.

32. The method of claim 31 wherein the second portion of the first value comprises more than half of the value.

33. The method of claim 32 wherein the second portion of the first value comprises at least two-thirds of the value.

34. The method of claim 28 wherein the first interval is an interval greater than one year.

35. The method of claim 34 wherein the first interval is an interval of at least three years.

36. The method of claim 35 wherein the first interval is an interval of at least five years.

37. The method of claim 28 further comprising the step of:
obligating the second trust, after the passage of a second interval after the credit event, to pay monies left over after provision of the indemnification and defense services to a charity.

38. The method of claim 28 further comprising the step of transferring second value from the sponsor to the first trust, said second value selected to induce sale of the securities.

39. The method of claim 28 wherein the indemnification and defense services comprise legal defense.

40. The method of claim 28 wherein the indemnification and defense services comprise payment of claims.

41. The method of claim 28 wherein the indemnification and defense services comprise payment of monies in settlement of claims.

42. The method of claim 28 further comprising the step, performed before the step of receiving indemnification and defense services, of presenting, by the director or officer, a claim for indemnification and defense services.

43. The method of claim 28 further comprising a first repetition of the steps of claim 28 at a first later time.

44. The method of claim 56 further comprising a second repetition of the steps of claim 28 at a second time later than the first later time.

45. The method of claim 44 wherein the first later time is a year later, and the second later time is a year after the first later time.

46. A method practiced with respect to a sponsor having credit and with respect to directors and officers of the sponsor, and with respect to a first trust and a second trust, the first trust obligated to sell securities linked to the credit of the sponsor, the proceeds of the sale defining first value, the sale occurring on a first date, the first trust obligated to transfer a first portion of the first value to the second trust in the event of a credit event with respect to the sponsor occurring within a first interval of the first date, thereby defining a second portion of the first value in the first trust; the method comprising the step of:
by an director or officer, making a claim for indemnification and defense services from the second trust, the indemnification and defense services paid for by the first portion of the first value.

47. The method of claim 46 wherein the credit event is bankruptcy of the sponsor.

48. The method of claim 46 wherein, if the first interval passes in the absence of a credit event with respect to the sponsor, the securities are redeemed.

49. The method of claim 46 further comprising the step, in the event of the credit event, of redeeming the securities at a price defined by the second portion of the first value.

50. The method of claim 49 wherein the second portion of the first value comprises more than half of the value.

51. The method of claim 50 wherein the second portion of the first value comprises at least two-thirds of the value.

52. The method of claim 46 wherein the first interval is an interval greater than one year.

53. The method of claim 52 wherein the first interval is an interval of at least three years.

54. The method of claim 53 wherein the first interval is an interval of at least five years.

55. The method of claim 46 further comprising the step of:
obligating the second trust, after the passage of a second interval after the credit event, to pay monies left over after provision of the indemnification and defense services to a charity.

56. The method of claim 46 further comprising the step of transferring second value from the sponsor to the first trust, said second value selected to induce sale of the securities.

57. The method of claim 46 further comprising the step, performed after the step of receiving indemnification and defense services, of receiving, by the director or officer, the indemnification and defense services.

58. The method of claim 57 wherein the indemnification and defense services comprise legal defense.

59. The method of claim 57 wherein the indemnification and defense services comprise payment of claims.

60. The method of claim 57 wherein the indemnification and defense services comprise payment of monies in settlement of claims.

61. The method of claim 46 further comprising a first repetition of the steps of claim 46 at a first later time.

62. The method of claim 61 further comprising a second repetition of the steps of claim 46 at a second time later than the first later time.

63. The method of claim 62 wherein the first later time is a year later, and the second later time is a year after the first later time.

64. A method practiced with respect to a sponsor having credit and with respect to directors and officers of the sponsor, and with respect to a first trust and a second trust, the first trust obligated to sell securities linked to the credit of the sponsor, the proceeds of the sale defining first value, the sale occurring on a first date, the first trust obligated to transfer a first portion of the first value to the second trust in the event of a credit event with respect to the sponsor occurring within a first interval of the first date, thereby defining a second portion of the first value in the first trust; the method comprising the step of:
managing indemnification and defense claims from directors or officers made with respect to indemnification and defense services from the second trust, the indemnification and defense services paid for by the first portion of the first value.

65. The method of claim 64 wherein the credit event is bankruptcy of the sponsor.

66. The method of claim 64 wherein, if the first interval passes in the absence of a credit event with respect to the sponsor, the securities are redeemed.

67. The method of claim 64 further comprising the step, in the event of the credit event, of redeeming the securities at a price defined by the second portion of the first value.

68. The method of claim 67 wherein the second portion of the first value comprises more than half of the value.

69. The method of claim 68 wherein the second portion of the first value comprises at least two-thirds of the value.

70. The method of claim 64 wherein the first interval is an interval greater than one year.

71. The method of claim 70 wherein the first interval is an interval of at least three years.

72. The method of claim 71 wherein the first interval is an interval of at least five years.

73. The method of claim 64 further comprising the step of:
obligating the second trust, after the passage of a second interval after the credit event, to pay monies left over after provision of the indemnification and defense services to a charity.

74. The method of claim 64 further comprising the step of transferring second value from the sponsor to the first trust, said second value selected to induce sale of the securities.

75. The method of claim 64 further comprising the step, performed after the step of receiving a claim for indemnification and defense services, of providing, to the director or officer, the indemnification and defense services.

76. The method of claim 75 wherein the indemnification and defense services comprise legal defense.

77. The method of claim 75 wherein the indemnification and defense services comprise payment of claims.

78. The method of claim 75 wherein the indemnification and defense services comprise payment of monies in settlement of claims.

79. The method of claim 64 further comprising a first repetition of the steps of claim 64 at a first later time.

80. The method of claim 79 further comprising a second repetition of the steps of claim 64 at a second time later than the first later time.

81. The method of claim 79 wherein the first later time is a year later, and the second later time is a year after the first later time.
